(19) United States
(12) Patent Application Publication
(10) Pub. No.: US 2007/0194281 A1
(43) Pub. Date: Aug. 23, 2007

(54) Light accumulating and luminous materials and a process to produce same

(75) Inventor: Dian Kun Gao, Dalian E.T.D.Z (CN)

Correspondence Address: OGILVY RENAULT LLP, 1981 MCGILL COLLEGE AVENUE, SUITE 1600, MONTREAL, QC, H3A2Y3, CA

(73) Assignee: TERRALIUM INDUSTRIES INC., Boucherville (CA)

(21) Appl. No.: 11/785,968

(22) Filed: Apr. 23, 2007

Related U.S. Application Data
(63) Continuation of application No. 10/964,606, filed on Oct. 15, 2004, now abandoned.

(51) Int. Cl. C09K 11/77

(52) U.S. Cl. 252/301.4 R

(57) ABSTRACT

The present invention relates to a light accumulating and luminous material characterized by the general formula M_{1-x-y}n(Al_{2-z}Ga_{z})O₄:xE⁺²,yRE wherein M is at least one alkaline earth metal; RE is at least one rare earth metal, and Al(OH)₃, Ga₂O₃, and Eu₂O₃ are also feed materials. In the formula, n ranges from 0.5 to 7; x ranges from 0.001 to 0.1; y ranges from 0.001 to 0.1; and z ranges from 0.005 to 0.05. It also relates to a process to manufacture the light accumulating and luminous material.

### BACKGROUND OF THE INVENTION

1) Field of the Invention

This invention relates to the field of light accumulating and luminous materials and, more particularly, to a light accumulating and luminous material including a gallium aluminate as a substance and a rare earth metal ion as an activator. It also relates to a process to manufacture the same.

2) Description of the Prior Art

It is known in the art that materials having the general chemical composition M₁₋ₓAl₂O₄:xRE are light accumulating and luminous, M being one or more than one element selected from the group consisting of calcium, strontium, and barium and RE being one or more of the lanthanide elements.

Typically, unitary Al₂O₃ of α-type, compound of alkaline earth metal, compounds of rare earth metals, flux, and other feed are cured at a high temperature in a reducing environment to obtain a firing hard product. The product is mechanically broken, ground, and screened. The luminance, the time of afterglow, the speed response for absorbing and emitting light, and the like are reduced since the perfect crystal is destroyed. Consequently, the loss and manufacturing costs are increased.

Moreover, if these light accumulating and luminous materials are mixed with coatings, the material color becomes gray. Consequently, its luminance, time of afterglow, and response speed are reduced. Moreover, its use value including its appearance, quality, and use limits is affected.

### SUMMARY OF THE INVENTION

It is an object of the present invention to provide a light accumulating and luminous material that has a higher luminance and a longer time of afterglow than prior materials.

It is another object of the present invention to provide a light accumulating and luminous material that preferably does not include any radioactive substances and is not a public nuisance.

It is a further object of the present invention to provide a light accumulating and luminous material that can be used in any condition.

According to one aspect of the present invention, there is provided a light accumulating and luminous material characterized by the general formula M_{1-x-y}n(Al_{2-z}Ga_{z})O₄:xEu⁺²,yRE wherein M is at least one alkaline earth metal selected from the group consisting of: Mg, Ca, Sr, and Ba; RE is at least one rare earth metal selected from the group consisting of: Sc, Y, La, Ce Pr, Nd, Sm, Gd, Tb, Dy, Ho, Er, Eu, Pm, Tm, Yb, and Lu; Al(OH)₃, Ga₂O₃, and Eu₂O₃ are feed materials for the Al, Ga, and Eu elements; n ranges from 0.5 to 7; x ranges from 0.001 to 0.1; y ranges from 0.001 to 0.1; and z ranges from 0.001 to 0.05.

Advantageously, the invention also relates to a process for the production of a light accumulating and luminous material comprising: providing a feed material including at least one oxide of a rare earth metal selected from the group consisting of Sc, Y, La, Ce Pr, Nd, Sm, Gd, Tb, Dy, Ho, Er, Eu, Pm, Tm, Yb, and Lu; at least one compound including an alkaline earth metal selected from the group consisting of: Mg, Ca, Sr, and Ba; Al(OH)₃, Ga₂O₃, and Eu₂O₃; grinding said feed material; fritting said ground feed material in a reducing environment; cooling down said fritted material; and mechanically breaking said fritted material to obtain said light accumulating and luminous material; wherein said light accumulating and luminous material has the general formula M_{1-x-y}n(Al_{2-z}Ga_{z})O₄:xEu⁺²,yRE, M being at least one alkaline earth metal selected from the group consisting of: Mg, Ca, Sr, and Ba; RE being at least one rare earth metal selected from the group consisting of: Sc, Y, La, Ce Pr, Nd, Sm, Gd, Tb, Dy, Ho, Er, Eu, Pm, Tm, Yb, and Lu; n ranging from 0.5 to 7; x ranging from 0.001 to 0.1; y ranging from 0.001 to 0.1; and z ranging from 0.001 to 0.05.

Advantageously, M may be selected from the group consisting of: Mg, Sr or a mixture thereof. Preferably, M may be added as at least one of a magnesium oxide and a strontium carbonate.

Advantageously, RE may be selected from the group consisting of: Nd, Dy or a mixture thereof. Preferably, RE may be added as at least one of an oxide of Nd and an oxide of Dy.

Advantageously, n may be 1 or 7.

Preferably, x may range from 0.001 to 0.005.

Preferably, y may range from 0.001 to 0.005.

Preferably, z may range from 0.005 to 0.05.

Advantageously, said feed material further comprises H₃BO₃ in an amount ranging from 0.05 to 0.5 mol per mol of said light accumulating and luminous material produced.

Preferably, said H₃BO₃ is added in an amount ranging from 0.05 to 0.1 mol per mol of said light accumulating and luminous material produced.

Advantageously, said process according to the invention may further comprise a step comprising screening said mechanically broken material.

Advantageously, said process according to the invention may further comprise a step comprising washing said fritted material with an alcohol solution of cutback hydrochloric. Preferably, said alcohol solution of cutback hydrochloric may have a concentration ranging from 5 to 10% wt.

Advantageously, said process according to the invention may further comprise a step comprising filtering said washed material.

Advantageously, said process according to the invention may further comprise a step comprising vacuum drying said filtered material.

Advantageously, said process according to the invention may further comprise a step where said feed material is ground in a ball-mill enamel pot containing agate balls. Preferably, the quantity of said agate balls in said ball-mill enamel pot may be twice the quantity of said feed material.

Advantageously, said process according to the invention may further comprise a step wherein the temperature is gradually increased during said sintering to a maximal temperature ranging from 1250 to 1350° C.

Advantageously, said process according to the invention may further comprise a step wherein said material is maintained between one and two hours at said maximal temperature.

Advantageously, said process according to the invention may further comprise a step wherein said ground material is sintered in an alumina crucible.

Advantageously, said process according to the invention may further comprise a step wherein said reducing gas comprises hydrogen and nitrogen.

### BRIEF DESCRIPTION OF THE DRAWINGS

Further features and advantages of the present invention will become apparent from the following detailed description, taken in combination with the appended drawing, in which:

FIG. 1 is a schematic flow diagram for the production of a light accumulating and luminous material according to a preferred embodiment of the present invention.

It will be noted that throughout the appended drawings, like features are identified by like reference numerals.

### DETAILED DESCRIPTION OF THE PREFERRED EMBODIMENT

A light accumulating and luminous material is also referred to as a long afterglow luminescent material or a colloquially luminous material. The novel features of the light accumulating and luminous material of the present invention relate to its substance and activator. The substance is a gallium aluminate of an alkaline earth metal such as magnesium, calcium, strontium, and barium. The activators are europium and another ion of a rare earth metal such as scandium, yttrium, lanthanum, cerium, praseodymium, neodymium, samarium, gadolinium, terbium, dysprosium, erbium, holmium, thulium, europium, promethium ytterbium, and lutetium.

The general chemical formula of the light accumulating and luminous material is
M_{1-x-y}n(Al_{2-z}Ga_{z})O₄:xEu⁺²,yRE.

M is at least one alkaline earth metal selected from the group consisting of: Mg, Ca, Sr and Ba (preferably Mg or Sr). RE is at least one rare earth metal selected from the group consisting of Sc, Y, La, Ce Pr, Nd, Sm, Gd, Tb, Dy, Ho, Er, Eu, Pm, Tm, Yb, and Lu (preferably Nd or Dy). The coefficients n, x, y, and z refer to the quantity of each element in the light accumulating and luminous material wherein n ranges from 0.5 to 7, x ranges from 0.001 to 0.1, y ranges from 0.001 to 0.1, and z ranges from 0.001 to 0.05. Preferably, n is 1 or 7, x ranges from 0.001 to 0.005, y ranges from 0.001 to 0.005, and z ranges from 0.005 to 0.05.

A magnesium oxide and/or a strontium carbonate may be preferably used as a feed material for M, the alkaline earth metal. Oxides of neodymium and/or dysprosium may be preferably used as a feed material for RE, the rare earth metal.

Al(OH)₃, Ga₂O₃, and Eu₂O₃ may be preferably used as feed materials for the Al, Ga, and Eu molecules of the material. H₃BO₃ may be optionally added as a flux to facilitate the solid phase reaction of the light accumulating and luminous material M_{1-x-y}n(Al_{2-z}Ga_{z})O₄:xEu⁺²,yRE in a high temperature environment. H₃BO₃ is preferably added in a concentration ranging from 0.05 to 0.5 mol, preferably from 0.05 to 0.1 mol per mol of the light accumulating and luminous material.

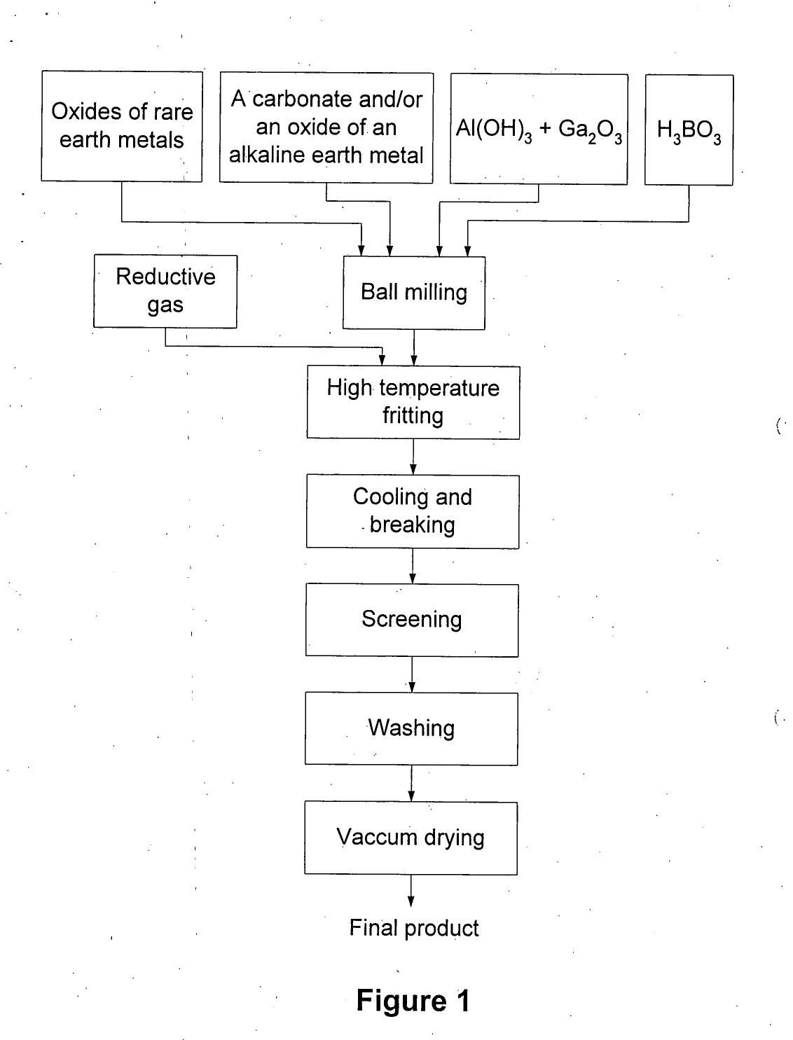

Referring to FIG. 1, it will be seen that the feed materials, preferably the oxides of rare earth metal, the alkaline earth metal carbonate and/or an alkaline earth metal oxide, Al(OH)₃, Ga₂O₃, and H₃BO₃, are ball milled and fritted at a high temperature with a reductive gas, as it will be explained in greater detailed later. Advantageously, the oxides of rare earth metal include the feed material Eu₂O₃ and the oxide used as a feed material for RE. The fritting is preferably carried out with a temperature gradually increasing until it reaches a temperature ranging between 1250 and 1350° C. The reductive gas is preferably a mixture of hydrogen and nitrogen. It may also contain a small quantity of ammonia gas. The product is preferably maintained between one to two hours at this temperature. The fritted product is then cooled down, broken (advantageously mechanically broken or ground), and screened. The screened product may be preferably washed with an alcohol solution of cutback hydrochloric whose concentration ranges from 5 to 10 % wt. Advantageously, the washed product may be finally filtered and vacuum dried to obtain the final product.

When it is dealt with an alcohol solution of cutback hydrochloric, the light accumulating and luminous material surprisingly show a higher luminance, a longer afterglow time, and a faster response speed for absorbing and emitting light. Advantageously, the alcohol solution of cutback hydrochloric eliminates the flux that has not reacted during the light accumulating and luminous material preparation and some impurities. Advantageoulsy, therefore, the purity of the light accumulating and luminous material of the invention is higher than the one of other well-known light accumulating and luminous materials.

Simultaneously, the alcohol solution of cutback hydrochloric dispels the disadvantageous dropping of luminance and afterglow when it is preferably mixed with coatings. The gray phenomenon that occurs when a light accumulating and luminous material is mixed with coatings is advantageously eliminated with the light accumulating and luminous material of the invention. Advantageously, the use effect is maintained, the use quality is raised, and the use scope is expanded comparatively to other well-known light accumulating and luminous materials.

Advantageously, the light accumulating and luminous material also includes an hydroxide of aluminum Al(OH)₃ as a feed material and thus liberates a certain quantity of water vapor during the high temperature solid phase reaction. Preferably, the firing product becomes loose and can be easily broken and its luminance and afterglow losses are lessened. Advantageously, the final product has a smaller degree of breakdown, keeps its high luminance, long afterglow, and fast response speed.

Advantageously, the quantity of trap in the crystal forbidden region is increased since the light accumulating and luminous material preferably contains gallium. Therefore, the luminescence probability of luminescence center is advantageously increased and the luminance and time of afterglow are also advantageously increased.

The material may absorb light, preferably sunshine and light having wavelengths in the rage of 200 to 400 nm. The light energy is stored in the crystal. In a dark environment, the material emits a visible light of specific wavelength.

Advantageously, the light accumulating and luminous material of the present invention provides long afterglow. Depending on its components, it may emit different colors such as blue green, green, yellow green, etc. as it will be shown in the following examples.

Advantageoulsy, the light accumulating and luminous material of the present invention has a higher luminance and a longer time of afterglow than the prior materials. It also has a better chemical stability. It does not include any radioactive substance and is not a public nuisance. It has a good resistance to corrosion and heat. Moreover, it can emit light in a high temperature environment, i.e. its highest luminance is around 300° C. Finally, it can be used in any condition.

### EXAMPLE 1

This first example relates to the manufacture of a light accumulating and luminous material according to the present invention. To manufacture the light accumulating and luminous material, the feed materials mentioned in Table 1 are weighted. Table 1 contains a description of the feed materials, their specification or purity, and their quantity, in mol, to manufacture a predetermined light accumulating and luminous material. The abbreviation “AR grade” stands for analytical reagent grade. The weighted materials were fed into a ball-mill enamel pot including agate balls of various size. Preferably, the quantity of agate balls was twice the quantity of the feed material. The feed materials were ground during approximately 24 hours at a rotation speed of 60 to 100 rpm. One skilled in the art will appreciate that these parameters can easily be modified depending on the nature of the material to be ground and the volume of the ball-mill enamel pot. The ground mixture obtained was put into an alumina crucible and the alumina crucible containing the ground mixture was heated in a high temperature kiln (or furnace) with a nitrogen air stream. The nitrogen air stream also contained about 5% of hydrogen and ammonia gas. The temperature was gradually raised up to 1250 and 1350° C. and maintained at that temperature during 1 to 2 hours. Thereafter, the temperature was cooled down gradually. The crucible containing the firing product was removed from the kiln and cooled to ambient temperature. The firing product was broken, screened with nylon, and fractionated. The screened product was washed with an alcohol solution of cutback hydrochloric whose concentration varied between 5 to 10% wt. The washed product was filtered and the alcohol solution of cutback hydrochloric was recovered. The filtered product was vacuum dried to obtain the final product.

The chemical composition of the final product was Sr_{0.994}(Al_{1.995}Ga_{0.005})O₄:0.0025Eu⁺²,0.0035Dy⁺² and its luminescent color was green.

TABLE 1

| No. | Molecular formula | Specification or purity | Quantity of mol |
|---|---|---|---|
| 1 | SrCO₃ | AR grade | 0.994 |
| 2 | Eu₂O₃ | Fluorescence grade | 0.005 |
| 3 | Dy₂O₃ | Fluorescence grade | 0.007 |
| 4 | Al(OH)₃ | AR grade | 1.994 |
| 5 | Ga₂O₃ | AR grade | 0.01 |
| 6 | H₃BO₃ | AR grade | 0.08 |

### EXAMPLE 2

This second example relates to the manufacture of another light accumulating and luminous material with the feed materials mentioned in Table 2. The accumulating and luminous material was manufactured as the material of example 1. The chemical composition of the final product was Sr_{0.993}(Al_{1.995}Ga_{0.005})O₄:0.0035Eu⁺²,0.0035Nd⁺² and its luminescent color was blue green.

TABLE 2

| No. | Molecular formula | Specification or purity | Quantity of mol |
|---|---|---|---|
| 1 | SrCO₃ | AR grade | 0.993 |
| 2 | Eu₂O₃ | Fluorescence grade | 0.007 |
| 3 | Nd₂O₃ | Fluorescence grade | 0.007 |
| 4 | Al(OH)₃ | AR grade | 1.995 |
| 5 | Ga₂O₃ | AR grade | 0.01 |
| 6 | H₃BO₃ | AR grade | 0.08 |

### EXAMPLE 3

Example 3 relates to the manufacture of another light accumulating and luminous material with the feed materials mentioned in Table 3 and with the above-described method. The chemical composition of the final product was Sr_{3.991}(Al_{6.98}Ga_{0.02})O₂₅:0.004Eu⁺²,0.005Dy⁺² and its luminescent color was blue green.

TABLE 3

| No. | Molecular formula | Specification or purity | Quantity of mol |
|---|---|---|---|
| 1 | SrCO₃ | AR grade | 3.991 |
| 2 | Eu₂O₃ | Fluorescence grade | 0.008 |
| 3 | Dy₂O₃ | Fluorescence grade | 0.01 |
| 4 | Al(OH)₃ | AR grade | 6.98 |
| 5 | Ga₂O₃ | AR grade | 0.04 |
| 6 | H₃BO₃ | AR grade | 0.08 |

### EXAMPLE 4

Example 4 relates to the manufacture of another light accumulating and luminous material with the feed materials mentioned in Table 4 and with the above-described method. The chemical composition of the final product was Sr_{0.893}Mg_{0.1}(Al_{1.995}Ga_{0.005})O₄:0.003Eu⁺²,0.004Dy⁺² and its luminescent color was yellow green.

TABLE 4

| No. | Molecular formula | Specification or purity | Quantity of mol |
|---|---|---|---|
| 1 | SrCO₃ | AR grade | 0.893 |
| 2 | MgO | AR grade | 0.1 |
| 3 | Eu₂O₃ | Fluorescence grade | 0.06 |
| 4 | Dy₂O₃ | Fluorescence grade | 0.08 |
| 5 | Al(OH)₃ | AR grade | 1.995 |
| 6 | Ga₂O₃ | AR grade | 0.01 |
| 7 | H₃BO₃ | AR grade | 0.08 |

The light accumulating and luminous material of the present invention can be used in a large variety of applications such as in painting, sculpture, plastics, and several other civilian and military fields.

The embodiments of the invention described above are intended to be exemplary only. The scope of the invention is therefore intended to be limited solely by the scope of the appended claims.

What is claimed is:

1. A light accumulating and luminous material characterized by the general formula M_{1-x-y}n(Al_{2-z}Ga_{z})O₄:xEu⁺²,yRE wherein
M is at least one alkaline earth metal selected from the group consisting of: Mg, Ca, Sr, and Ba;
RE is at least one rare earth metal selected from the group consisting of: Sc, Y, La, Ce Pr, Nd, Sm, Gd, Tb, Dy, Ho, Er, Eu, Pm, Tm, Yb, and Lu;
Al(OH)₃, Ga₂O₃, and Eu₂O₃ are feed materials for the Al, Ga, and Eu elements;
n ranges from 0.5 to 7;
x ranges from 0.001 to 0.1;
y ranges from 0.001 to 0.1; and
z ranges from 0.001 to 0.05.

2. A light accumulating and luminous material as claimed in claim 1, wherein M is selected from the group consisting of: Mg, Sr or a mixture thereof.

3. A light accumulating and luminous material as claimed in claim 2, wherein M is added as at least one of a magnesium oxide and a strontium carbonate.

4. A light accumulating and luminous material as claimed in claim 1, wherein RE is selected from the group consisting of: Nd, Dy or a mixture thereof.

5. A light accumulating and luminous material as claimed in claim 4, wherein RE is added as at least one of an oxide of Nd and an oxide of Dy.

6. A light accumulating and luminous material as claimed in claim 1, wherein n is 1 or 7.

7. A light accumulating and luminous material as claimed in claim 1, wherein x ranges from 0.001 to 0.005.

8. A light accumulating and luminous material as claimed in claim 1, wherein y ranges from 0.001 to 0.005.

9. A light accumulating and luminous material as claimed in claim 1, wherein z ranges from 0.005 to 0.05.

10. A process for the production of a light accumulating and luminous material comprising:
providing a feed material including
at least one oxide of a rare earth metal selected from the group consisting of Sc, Y, La, Ce Pr, Nd, Sm, Gd, Tb, Dy, Ho, Er, Eu, Pm, Tm, Yb, and Lu;
at least one compound including an alkaline earth metal selected from the group consisting of: Mg, Ca, Sr, and Ba;
Al(OH)₃, Ga₂O₃, and Eu₂O₃;
grinding said feed material;
fritting said ground feed material in a reducing environment;
cooling down said fritted material; and
mechanically breaking said fritted material to obtain said light accumulating and luminous material;
wherein said light accumulating and luminous material has the general formula M_{1-x-y}n(Al_{2-z}Ga_{z})O₄:xEu⁺²,yRE,
M being at least one alkaline earth metal selected from the group consisting of: Mg, Ca, Sr, and Ba;
RE being at least one rare earth metal selected from the group consisting of: Sc, Y, La, Ce Pr, Nd, Sm, Gd, Tb, Dy, Ho, Er, Eu, Pm, Tm, Yb, and Lu;
n ranging from 0.5 to 7;
x ranging from 0.001 to 0.1;
y ranging from 0.001 to 0.1; and
z ranging from 0.001 to 0.05.

11. A process as claimed in claim 10, wherein M is selected from the group consisting of: Mg, Sr or a mixture thereof.

12. A process as claimed in claim 11, wherein the feed material for M is selected from the group consisting of: a magnesium oxide, a strontium carbonate or a mixture thereof.

13. A process as claimed in claim 10, wherein RE is selected from the group consisting of: Nd, Dy or a mixture thereof.

14. A process as claimed in claim 13, wherein the feed material for RE is selected from the group consisting of: an oxide of Nd, an oxide of Dy, or a mixture thereof.

15. A process as claimed in claim 10, wherein n is 1 or 7.

16. A process as claimed in claim 10, wherein x ranges from 0.001 to 0.005.

17. A process as claimed in claim 10, wherein y ranges from 0.001 to 0.005.

18. A process as claimed in claim 10, wherein z ranges from 0.005 to 0.05.

19. A process as claimed in claim 10, wherein said feed material further comprises H₃BO₃ in an amount ranging from 0.05 to 0.5 mol per mol of said light accumulating and luminous material produced.

20. A process as claimed in claim 19, wherein said H₃BO₃ is added in an amount ranging from 0.05 to 0.1 mol per mol of said light accumulating and luminous material produced.

21. A process as claimed in claim 10, further comprising screening said mechanically broken material.

22. A process as claimed in claim 10, further comprising washing said fritted material with an alcohol solution of cutback hydrochloric.

23. A process as claimed in claim 22, wherein said alcohol solution of cutback hydrochloric has a concentration ranging from 5 to 10% wt.

24. A process as claimed in claim 22, further comprising filtering said washed material.

25. A process as claimed in claim 24, further comprising vacuum drying said filtered material.

26. A process as claimed in claim 10, wherein said feed material is ground in a ball-mill enamel pot containing agate balls.

27. A process as claimed in claim 26, wherein the quantity of said agate balls in said ball-mill enamel pot is twice the quantity of said feed material.

28. A process as claimed in claim 10, wherein the temperature is gradually increased during said sintering to a maximal temperature ranging from 1250 to 1350° C.

29. A process as claimed in claim 28, wherein said material is maintained between one and two hours at said maximal temperature.

30. A process as claimed in claim 10, wherein said ground material is sintered in an alumina crucible.

31. A process as claimed in claim 10, wherein said reducing gas comprises hydrogen and nitrogen.
